(19) United States
(12) Patent Application Publication
(10) Pub. No.: US 2015/0348170 A1
(43) Pub. Date: Dec. 3, 2015

(54) METHODS AND SYSTEMS FOR FACILITATING ENTERTAINMENT MEDIA LISTINGS USING UNIQUE USER IDENTIFIERS

(71) Applicants: Christopher Alan Wilber, Los Gatos, CA (US); Matthew Olson, San Jose, CA (US); Imad Jabbour, Belmont, CA (US); Vipul Govil, Fremont, CA (US)

(72) Inventors: Christopher Alan Wilber, Los Gatos, CA (US); Matthew Olson, San Jose, CA (US); Imad Jabbour, Belmont, CA (US); Vipul Govil, Fremont, CA (US)

(73) Assignee: EBAY INC., SAN JOSE, CA (US)

(21) Appl. No.: 14/288,270

(22) Filed: May 27, 2014

(51) Int. Cl. G06Q 30/06; G06F 17/24; G06F 17/30; G06Q 30/02

(52) U.S. Cl. CPC G06Q 30/0635; G06Q 30/0255; G06F 17/243; G06F 17/30876

(57) ABSTRACT

Systems and methods are presented for facilitating entertainment media listings using unique user identifiers. In some embodiments, a computer-implemented method is presented. The method may include accessing a unique user identifier of a user, the unique user identifier associated with at least one form of entertainment media, the unique user identifier including a user history of at least one form of the entertainment media accessed by the user. The method may also include transmitting first information for displaying an offer to conduct a consumer transaction of a product associated with the at least one form of entertainment media, wherein displaying the offer is based on the user history within the accessed unique user identifier.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2014, eBay Inc. All Rights Reserved.

### TECHNICAL FIELD

The subject matter disclosed herein generally relates to consumer transactions in a virtual marketplace. In some example embodiments, the present disclosures relate to systems and methods to facilitate entertainment media listings using unique user identifiers.

### BRIEF DESCRIPTION OF THE DRAWINGS

Some embodiments are illustrated by way of example and not limitation in the figures of the accompanying drawings.

FIG. 1 is block diagram illustrating a mobile device suitable for accessing a unique user identifier associated with at least one form of entertainment media and for facilitating entertainment media listings, according to some example embodiments.

FIG. 2 is an image of an example set of video gaming consoles utilized in some example embodiments.

FIG. 3 is a block diagram illustrating a network architecture suitable for accessing a unique user identifier associated with at least one form of entertainment media and for facilitating entertainment media listings, according to some example embodiments.

FIG. 4 is a block diagram illustrating an example display used to obtain a unique user identifier of a user, according to some example embodiments.

FIG. 5 is a diagram illustrating an example scenario for facilitating efficient setup of a product listing, according to some example embodiments.

FIG. 6 is a diagram illustrating an example product listing efficiently completed based on information form a unique user identifier, according to some example embodiments.

FIG. 7 is a flowchart illustrating example operations for facilitating entertainment media listings, according to some example embodiments.

FIG. 8 is a block diagram illustrating components of a machine, according to some example embodiments, able to read instructions from a machine-readable medium and perform any one or more of the methodologies discussed herein.

### DETAILED DESCRIPTION

As sales through digital or online marketplaces become ever more frequent and commonplace, it may be desirable to streamline or facilitate easier access to purchase or sell products in the online marketplace. For example, it is often the case that a merchant selling products in the online marketplace would need to manually fill out a fair amount of information in order to properly classify and place the product amongst the many listing categories of the online marketplace. Obtaining or filling out all the information not only slows down the process for selling products, but can also present a barrier to access the marketplace if a seller has trouble obtaining or completing all the information needed. As another example, a seller of used products possesses a certain type of inventory, having common or related characteristics consistent with the seller's preferences. For example, a seller may like a certain type of music, may prefer to play a certain type, genre, or category of video games, and the like. Similarly, buyers possess a certain type of preferences individually, as well. It may be desirable to find ways to contact sellers and buyers with common preferences, in order to more effectively generate a product transaction. In general, it may be desirable to improve methods for placing listings in the marketplace, and for reaching a more suitable set of customers to sell products through the marketplace.

Example methods, apparatuses and systems are presented for facilitating entertainment media listings using unique user identifiers. In some example embodiments, entertainment media can include video games, movies, or music manifested in physical or digital form, such as on Blu-rays®, DVDs, CDs, or digital files controlled through a unique user account. These various entertainment media can be listed for sale in an online marketplace. The product listings can be easily generated using unique user identifiers that can be used to access information about the product and the owner of the product. Information obtained based on the unique user identifiers can also help facilitate offers to purchase other entertainment media related to the products owned by the user, as well as facilitate offers to sell or purchase products at opportune times. These descriptions and more will be discussed in more detail below.

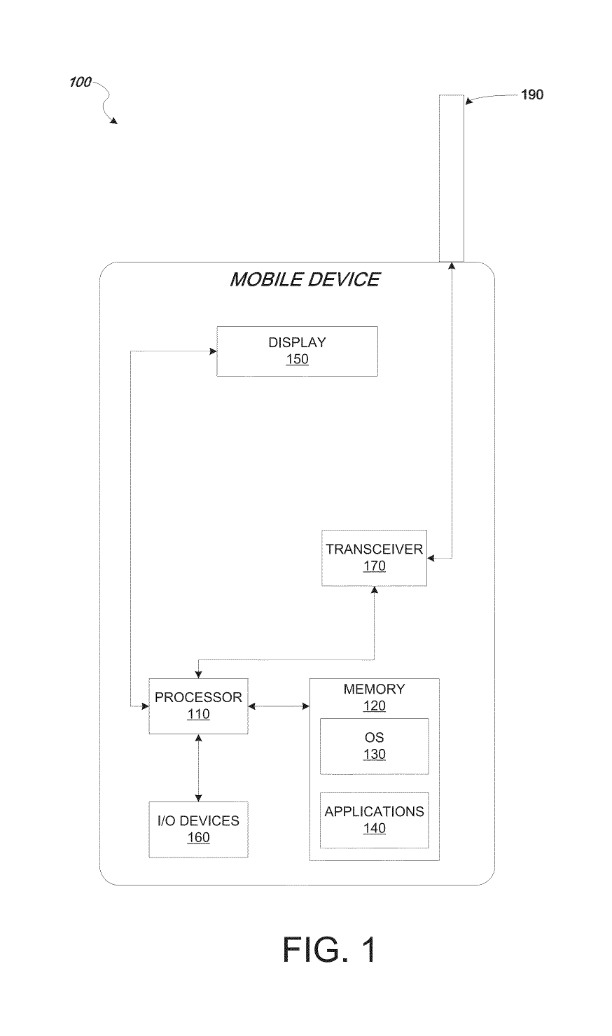

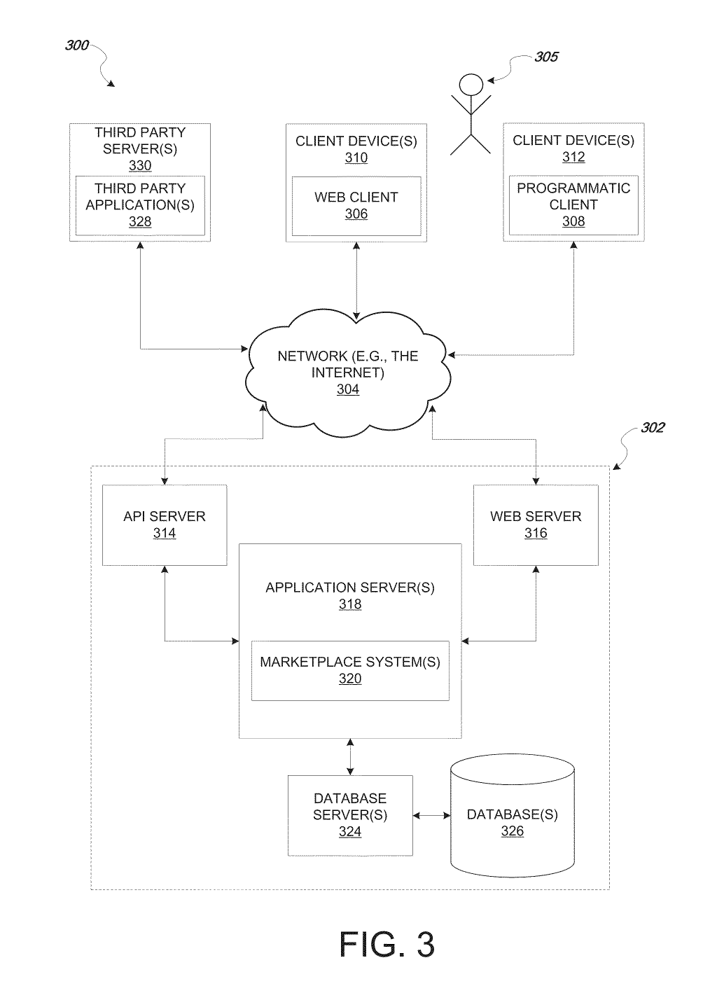

Referring to FIG. 1, a block diagram illustrating a mobile device 100 is presented, according to some example embodiments. The mobile device 100 may be configured to facilitate consumer transactions of entertainment media, according to at least some example embodiments. The mobile device 100 may be configured to access a unique user identifier from a user's account of one or more entertainment media. For example, the user may have a unique user identifier associated with a gaming center for games played on mobile device 100. As used herein, a unique user identifier may refer to a name, account ID, or some other marker that uniquely identifies a user account belonging to some kind of user community. The unique user identifier may have associated user and entertainment media information tied to it. Other types of information may be associated with the unique user identifier, which will be discussed in more detail below. An application 140 running on the mobile device 100 may utilize the user and entertainment media information obtained through the unique user identifier to facilitate consumer transactions related to entertainment media products owned by the user. The mobile device 100 may include a processor 110. The processor 110 may be any of a variety of different types of commercially available processors suitable for mobile devices 100 (e.g., an XScale architecture microprocessor, a Microprocessor without Interlocked Pipeline Stages (MIPS) architecture processor, or another type of processor). The processor 110 may be configured to operate applications 140 like the one mentioned above and access information associated with the unique user identifier. A memory 120, such as a random access memory (RAM), a Flash memory, or other type of memory, is typically accessible to the processor 110. The memory 120 may be adapted to store an operating system (OS) 130, as well as application programs 140, such as a mobile application for conducting consumer transactions utilizing information from unique user identifiers. The processor 110 may be coupled, either directly or via appropriate intermediary hardware, to a display 150 and to one or more input/output (I/O) devices 160, such as a keypad, a touch panel sensor, a microphone, a controller, a camera, and the like. Similarly, in some embodiments, the processor 110 may be coupled to a transceiver 170 that interfaces with an antenna 190. The transceiver 170 may be configured to both transmit and receive cellular network signals, wireless data signals, or other types of signals via the antenna 190, depending on the nature of the mobile device 100. In this manner, a connection with a network such as network 304 of FIG. 3, discussed more below, may be established.

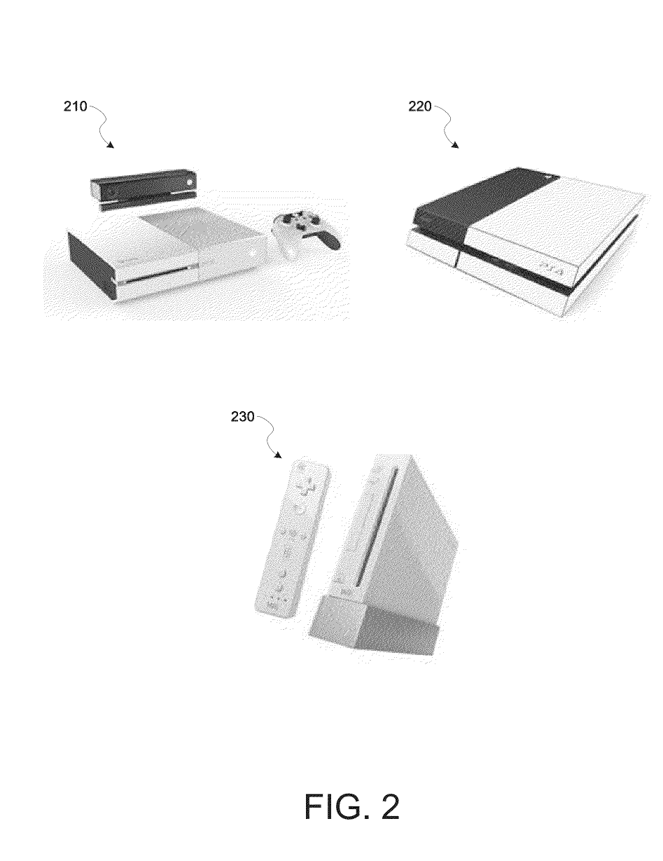

Referring to FIG. 2, example entertainment media systems utilizing aspects of the present disclosure are presented, according to some example embodiments. Example videogame console 210 may represent a Microsoft Xbox One® system. Example videogame console 220 may represent a Sony PlayStation 4® system. Example videogame console 230 may represent a Nintendo Wii U® system. Each of these example gaming systems 210, 220, and 230, may allow a user to play games through a unique user identifier. For example, a user may set up an Xbox Live Gamertag® as a unique account to play games on the Xbox One system 210, while the user can set up a PlayStation network ID as a unique account to play games on the PlayStation for system 220, while the user can set up a Nintendo Wii U user account and/or a Nintendo Network ID for use on the Nintendo Wii U system 230. A user can be uniquely identified within the respective gaming networks based on his or her unique account name, which is one example of a unique user identifier according to some example embodiments. Various information about the user and the user's preferences can be associated with these unique user identifiers, including the titles of games played by the user, the last time the user has played a specific game, how long the game has been played, various achievements earned in the game, and various personal information. In some example embodiments, applications 140 accessing information from a unique user identifier can interface with one or more of the example videogame systems 210, 220, and 230, in order to help facilitate buying and selling of various entertainment media. Example details will be discussed further according to the descriptions, below.

Referring to FIG. 3, a high-level client-server-based network architecture 300 is shown, according to some example embodiments. The network architecture 300 may include systems, applications 140, modules, and/or other means for utilizing aspects of the present disclosure, as may be apparent to those with skill in the art. For example, the network architecture 300 may include means for accessing one or more unique user identifiers and for facilitating consumer transactions of various entertainment media based on information associated with the unique user identifiers, according to aspects of the present disclosure. Example means can include software stored in application server(s) 318 configured to read a user 305's user profile containing the unique user identifier. An example user profile will be discussed in more detail below. Other example means can include software stored in marketplace system(s) 320 configured to display a prompt on client device 310 or 312, offering to facilitate the sale of one or more entertainment media. An example scenario of this exchange will be discussed in more detail below. In some example embodiments, a networked system 302 may facilitate a network-based marketplace or payment system 320, providing server-side functionality via a network 304 (e.g., the Internet or wide area network (WAN)) to one or more client devices 310 and 312. FIG. 3 illustrates, for example, a web client 306 (e.g., a browser, such as the Internet Explorer® browser developed by Microsoft®), and a programmatic client 308 executing on respective client devices 310 and 312. The network-based marketplace system 320 may include a website or other central repository for storing and displaying the images of the physical mockups.

Examples of client devices 310 and 312 may include, but are not limited to, a mobile phone, desktop computer, laptop, portable digital assistants (PDAs), smart phones, tablets, ultra books, netbooks, laptops, multi-processor systems, microprocessor-based or programmable consumer electronics, game consoles, handheld game systems, set-top boxes, or any other communication device that a user may utilize to access the networked system 302. Example client devices 310 and 312 may be consistent with the mobile device 100, described in FIG. 1, and video game consoles 210, 220, and 230, described in FIG. 2. In some embodiments, the client device 310 may comprise or be connected to a display module (not shown) to display information (e.g., in the form of user interfaces) and images. In further embodiments, the client device 310 may comprise one or more of touch screens, accelerometers, gyroscopes, cameras, microphones, global positioning system (GPS) devices, and so forth. In some examples embodiments, the networked system 302 is a network-based marketplace that responds to requests for product listings, publishes publications comprising item listings of products available on the network-based marketplace, and manages payments for these marketplace transactions. The product listings may include one or more images of the one or more various products. The images may include one or more composite images of a product as described herein. One or more users 305 may be a person, a machine, or other means of interacting with client devices 310 and 312. In embodiments, the user 305 is not part of the network architecture 300, but may interact with the network architecture 300 via client devices 310 and 312 or another means.

An application program interface (API) server 314 and a web server 316 may be coupled to, and provide programmatic and web interfaces respectively to, one or more application servers 318. The application servers 318 may host one or more marketplace systems 320, which may comprise one or more modules or applications 140 and which may be embodied as hardware, software, firmware, or any combination thereof. The application servers 318 are, in turn, shown to be coupled to one or more database servers 324 that facilitate access to one or more information storage repositories or database(s) 326. In some example embodiments, the databases 326 are storage devices that store information to be posted (e.g., publications or listings, images of products, etc.) to the marketplace system 320. The databases 326 may also store digital goods information in accordance with example embodiments.

The marketplace system(s) 320 may provide a number of marketplace functions and services to users 305 that access the networked system 302. For example, marketplace system(s) 320 may facilitate easier display of product listings by accessing information associated with one or more unique user identifiers for use in the product listings. As another example, the marketplace system(s) 320 may present an offer to place a listing for an entertainment media product owned by user 305, based on information about the product associated with one or more unique user identifiers. While the marketplace system(s) 320 is shown in FIG. 3 to form part of the networked system 302, it will be appreciated that, in alternative embodiments, the marketplace system(s) 320 may form part of a payment service that is separate and distinct from the networked system 302.

Further, while the client-server-based network architecture 300 shown in FIG. 3 employs a client-server architecture, the present inventive subject matter is, of course, not limited to such an architecture, and may equally well find application in a distributed, or peer-to-peer, architecture system, for example. The various marketplace system(s) 320 may also be implemented as standalone software programs, which do not necessarily have networking capabilities.

The web client 306 accesses the various marketplace system(s) 320 via the web interface supported by the web server 316. Similarly, the programmatic client 308 accesses the various services and functions provided by the marketplace system(s) 320 via the programmatic interface provided by the API server 314. The programmatic client 308 may, for example, be a seller application (e.g., the Turbo Lister application developed by eBay® Inc.) to enable sellers to author and manage listings on the networked system 302 in an off-line manner, and to perform batch-mode communications between the programmatic client 308 and the networked system 302.

Additionally, a third party application(s) 328, executing on a third party server(s) 330, is shown as having programmatic access to the networked system 302 via the programmatic interface provided by the API server 314. For example, the third party application 328, utilizing information retrieved from the networked system 302, may support one or more features or functions on a website hosted by the third party. The third party website may, for example, provide one or more promotional, marketplace, or payment functions that are supported by the relevant applications of the networked system 302. The third party server 330 may help facilitate the sale of products related to entertainment media used on client devices 310 and 312 by, for example, displaying advertisements on the client devices 310 and 312 based on information associated with one or more unique user identifiers.

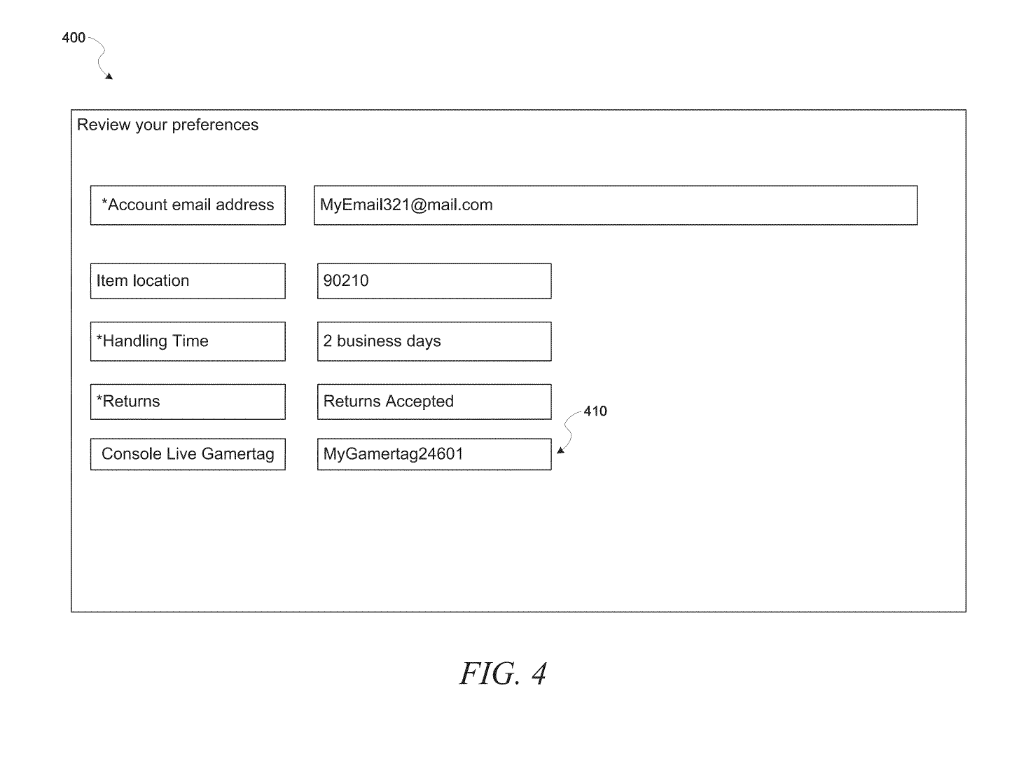

Referring to FIG. 4, illustration 400 shows an example display screen for obtaining unique user identifiers, used in example embodiments. Here, illustration 400 may depict a display screen for preparing a product listing, such as selling a video game on an online marketplace. The seller may need to enter various information to complete an initial product listing, such as an email address, ZIP code of where the product would be shipped from, estimated time for shipping, whether a buyer is allowed to return the product, and a unique user identifier 410. Examples of unique user identifiers 410 can include an Xbox Live Gamertag, PlayStation Network ID, and the like. In some example embodiments, unique user identifiers 410 can also include unique accounts for music or movies, and embodiments are not so limited. An example tool to set up a product listing can include the Quick Listing Tool designed by eBay, Inc. Given that a seller has already placed at least one product for sale in an online marketplace, it may be reasonable to think that the seller is open to considering placing additional products for sale in the online marketplace at other times. It may be reasonable to think that the seller may be open to utilizing methods and systems that more efficiently enable the seller to place additional products online. Utilizing the initial information provided by the seller in a product listing, such as in illustration 400, including the seller's email address and unique user ID, may be an effective way to help the seller efficiently place more products online in the future.

Other means for obtaining a unique user identifier 410 are possible, and embodiments are not so limited. For example, in some example embodiments, a prompt screen may ask whether the user 305 will allow his or her unique user identifier 410 to be accessed in order to more efficiently buy and sell products related to entertainment media that the user 305 has already purchased. As another example, when a user 305 creates a unique user ID 410, the network 304 may present a prompt screen asking whether the user 305 will allow his or her unique user ID 410 to be accessed.

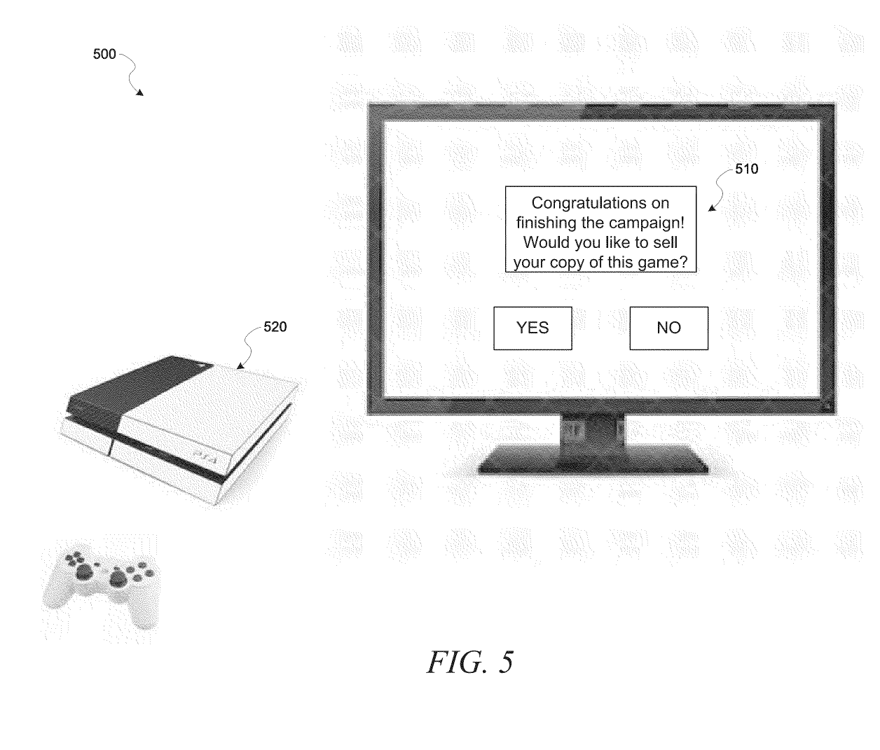

Referring to FIG. 5, example scenario 500 shows an example use of a unique user identifier 410, according to some example embodiments. Here, knowing a user 305's unique user identifier 410 can enable aspects of the present disclosure to determine, for example, every game the user 305 has played in the gaming network associated with the unique user identifier 410 (e.g., all games for Xbox 360® and Xbox One®, or all games for PlayStation 3®, PlayStation 4®, and PlayStation Vita®, etc.), achievements or trophies earned in the games that the user 305 has played, when was the last time the user 305 has played a certain game, and how long the user 305 has played the game. A system or application 140 according to aspects of the present disclosure can then determine when a user 305 has completed the purchased game, or reached a good stopping point. For example, often times when a game is completed, a particular achievement or trophy is earned, which can be determined and accessed via the unique user identifier 410. At this point, in some example embodiments, a prompt screen 510 or the like could be displayed to the user 305 on a display screen connected to a gaming console 520, asking whether the user 305 would like to sell the completed game. Presenting an offer to sell at this point may be beneficial for both the user 305 and any potential buyers, because if the user 305 does not consider selling now, the user 305 may forget about the game later. Also, the demand for buying a game decreases over time, and so a potential seller has an interest in trying to sell the game as quickly as possible, but perhaps after the seller has completed the game himself. Thus, the seller has the potential to make more money by selling the game earlier.

As another example, based on information from the unique user ID 410, it may be determined whether the user 305 has stopped playing a particular game prior to completing it. For example, a prompt screen asking whether the user 305 would like to sell a certain game could be displayed after it has been determined that the user 305 has not played the game for over 90 days.

In some example embodiments, price listings for the game can be presented to the user 305 before the user 305 needs to decide whether to sell the game. For example the online marketplace, such as marketplace system 320, may be able to access an average selling price of the game, which can then be presented to the seller. In some cases, due to the timeliness of selling the game upon completion or at least earlier than when the seller might otherwise consider selling, the seller may benefit with a higher average selling price.

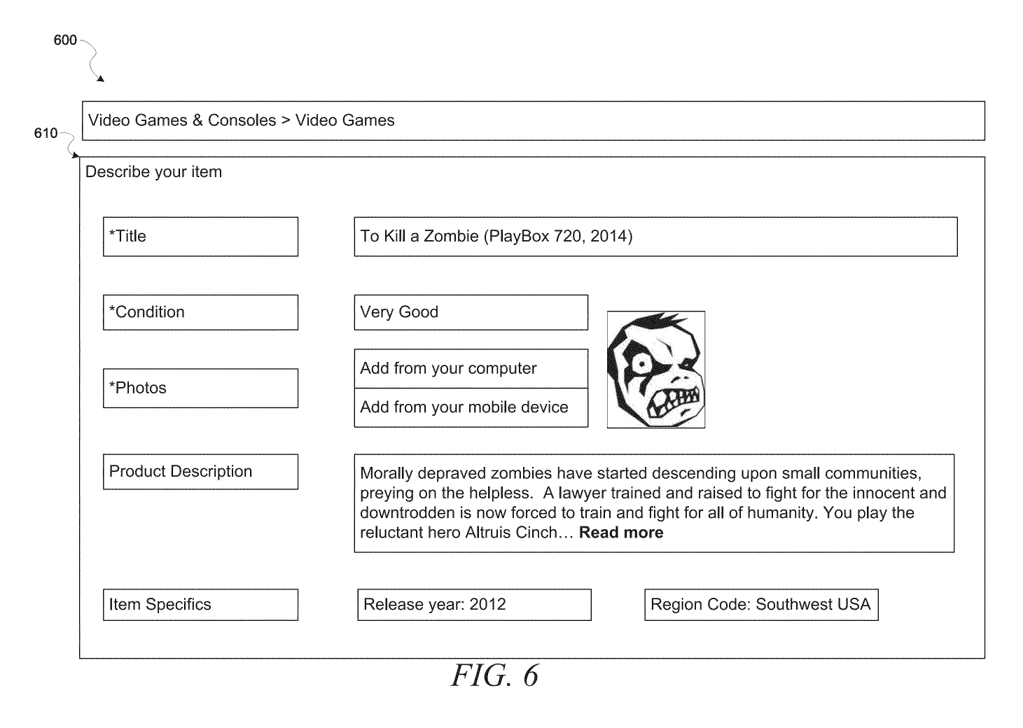

Referring to FIG. 6, example product listing 600 is presented, showing example information of a product listing, according to some example embodiments. With reference to FIG. 5, after the user 305 has decided to sell the recently completed game by responding to the prompt, in some example embodiments, the seller may be taken to another display screen showing a product listing 600 with much of the information already filled in, based on information obtained from the unique user identifier 410. For example, the title of the game, what console the seller played the game on, generic pictures of the game, and a generic description of the game can already be prefilled in the description of the product 610, based on what game is being sold to the unique user identifier 410. Additional default information and user preferences can also be prefilled in the description of the product 610, based on specified user preferences, and/or product listing history of that user 305. Thus, in some example embodiments, the seller need only enter the condition of the item (of which a subset of options could be surfaced because it is known that the item is used), and the games listing price. In this way, aspects of the present disclosure can allow for a streamlined approach to selling various entertainment media, based simply on having access to a unique user identifier 410.

In some example embodiments, various other forms of entertainment media can be offered for sale through similar means, including computer games, music CDs, DVD and Blu-ray movies or videos, and digital forms of any of these types of entertainment media. For example, unique user identifiers 410 associated with these other types of entertainment media, such as an iTunes user account, or a Steam account, may also contain user history and other account or personal information. For digital entertainment media, media publishers may limit the amount of digital copies accessible to any particular user 305, and the user 305 may therefore hold the rights to sell his access to those limited digital copies. Similar display prompts and other links to online marketplaces can be generated to facilitate easy access to sell these other forms of entertainment media. In general, any unique user identifier 410 associated with any of the various types of entertainment media, and which may enable access to some or all of the types of information described herein, could facilitate easier access to sell the user 305's various entertainment media, and embodiments are not so limited.

In some example embodiments, offers to purchase related entertainment media can also be presented to a user 305 based on similar types of information obtained from a unique user identifier 410. For example, aspects of the present disclosure can present offers to purchase various types of video games based on the titles in a series the user 305 has already played before (e.g. Assassins Creed®, Final Fantasy®), a genre of games commonly owned by the user 305 (e.g. racing, strategy, first-person shooter, competitive/cooperative gaming), a popular game designer of games the user 305 commonly plays (e.g. Ken Levine, David Cage), a niche publisher of games the user 305 commonly plays (e.g. Atlus®, XSeed®, Ignition Entertainment®), or other types of information gleamed from the unique user identifier 410 apparent to those with skill in the art. In some example embodiments, recommendations for types of games to purchase could also be based on games the user 305's friends have played or are playing, accessible in some cases based on a database of friends connected to the unique user identifier 410.

In some example embodiments, offers to purchase related music, movies, or other types of entertainment media can also be presented to the user 305 based on similar information from the unique user identifier 410 of these different types of entertainment media, consistent with the methods and concepts presented herein. For example, offers to purchase music from an artist or genre commonly listened to by the user 305, or offers to purchase movies a particular genre commonly watched by the user 305, and the like, can be presented to the user 305 through means consistent with the present disclosures and apparent to those with skill in the art.

In some example embodiments, these product listings and/or accepting these offers to purchase related products can be completed through voice activation means. For example, commands through voice recognition are available through some video game consoles and various mobile devices, the likes of which can be utilized by applications 140 facilitating the product listings or offers to purchase according to aspects of the present disclosure.

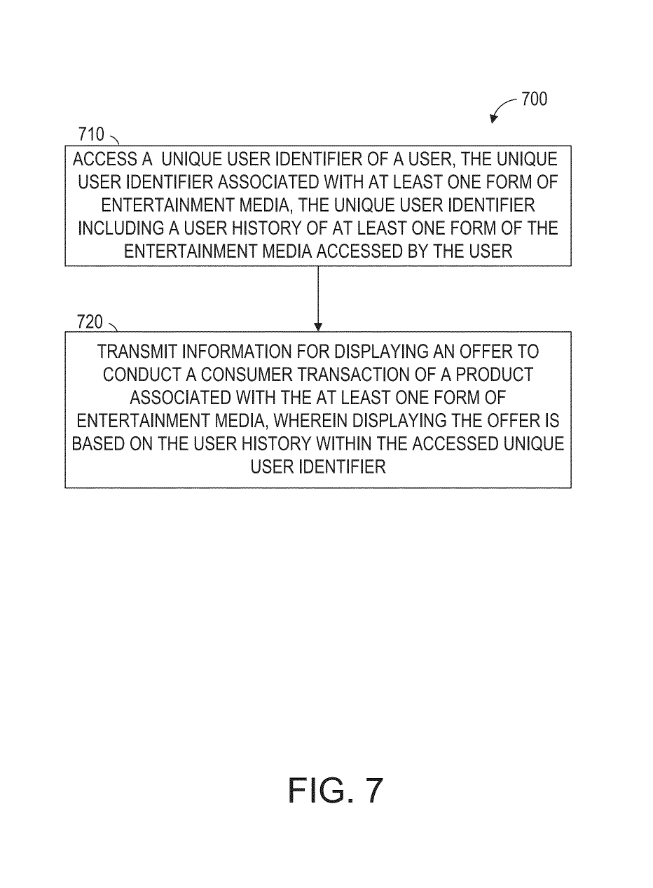

Referring to FIG. 7, the flowchart illustrates an example methodology 700 for facilitating entertainment media listings using unique user identifiers 410, according to aspects of the present disclosure. The example methodology may be consistent with the methods described herein, including, for example, the descriptions in FIGS. 1, 2, 3, 4, 5, and 6.

At block 710, a user device may access a unique user identifier 410 of the user 305, the unique user identifier 410 associated with at least one form of entertainment media. The unique user identifier 410 may also include a user history of at least one form of the entertainment media accessed by the user 305. In other cases, the unique user identifier 410 may be associated with a user history of at least one form of the entertainment media, which can be accessed by the user 305. Example user devices capable of executing the example methodology 700 may include mobile device 100, video game consoles 210, 220, 230, and client devices 310 and 312. Examples of the unique user identifier 410 may be any of the unique user identifiers 410 discussed in the disclosures herein, as well as other user identifiers apparent to those with skill in the art. In some example embodiments, examples of the at least one form of entertainment media may include categories of entertainment media, such as video games, computer games, music, and movies. In other cases, examples of the at least one form of entertainment media may include specific publishers and/or licensees within the categories of entertainment media, such as Sony®, Microsoft®, Apple®, and 21st Century Fox®. In other cases, the at least one form of entertainment media may include specific titles of entertainment media, such as a title of a videogame, or title of a movie. In some example embodiments, the user history may include times and dates or durations of times of when the user 305 has accessed the at least one form of entertainment media.

At block 720, the user device may transmit information for displaying an offer to conduct a consumer transaction of a product associated with the at least one form of entertainment media, where and displaying the offer is based on the user history within the accessed unique user identifier 410. In some example embodiments, the offer to conduct a consumer transaction may be an offer to sell a particular title of entertainment media that the user 305 may no longer want to own. In other cases, the offer to conduct a consumer transaction may be an offer to purchase a title related to entertainment media that the user 305 currently owns and is associated with a particular title that the user 305 has recently accessed. Other examples of offers to conduct a consumer transaction may be consistent with any of the descriptions herein, and embodiments are not so limited. In some example embodiments, examples of the offer being based on the user history may be consistent with any of the examples described herein, including the descriptions in FIGS. 4, 5, and 6. In some example embodiments, the offer may be generated by a marketplace system located at a remote location from the user device. An example marketplace system could be marketplace system 320. The accessed unique user identifier from block 710 may be transmitted to a database server in a network system, such as API server 314 or database server 324 in network system 302. The marketplace system may access the unique user identifier 410 and access associated user history to determine what may be a suitable offer to present to the user 305 via the user device. The network system 302 may then transmit the offer via the network 304 to the user device, which can then display the offer on a display screen associated with the user device. In other cases, preprogrammed software derived from marketplace system 320 may be loaded into the user device via the network 304. Then, whenever a suitable condition is identified for presenting an offer to the user, based on accessed user history associated with the unique user identifier 410, the offer can be generated by the user device and displayed on a display screen associated with the user device.

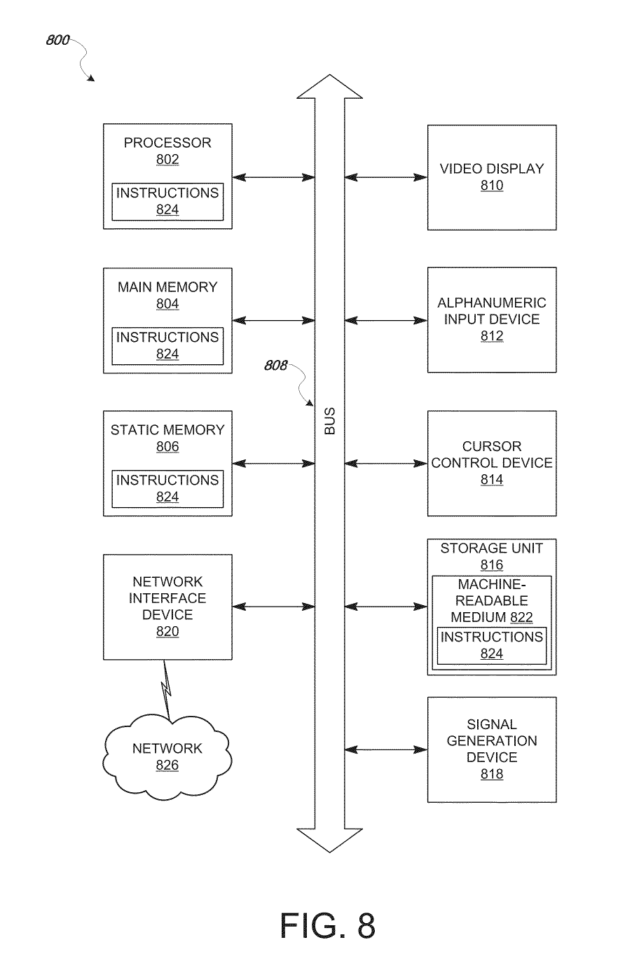

Referring to FIG. 8, the block diagram illustrates components of a machine 800, according to some example embodiments, able to read instructions 824 from a machine-readable medium 822 (e.g., a non-transitory machine-readable medium, a machine-readable storage medium, a computer-readable storage medium, or any suitable combination thereof) and perform any one or more of the methodologies discussed herein, in whole or in part. Specifically, FIG. 8 shows the machine 800 in the example form of a computer system (e.g., a computer) within which the instructions 824 (e.g., software, a program, an application 140, an applet, an app, or other executable code) for causing the machine 800 to perform any one or more of the methodologies discussed herein may be executed, in whole or in part.

In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a distributed (e.g., peer-to-peer) network environment. The machine 800 may include hardware, software, or combinations thereof, and may as examples be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 824, sequentially or otherwise, that specify actions to be taken by that machine. Further, while only a single machine 800 is illustrated, the term “machine” shall also be taken to include any collection of machines 800 that individually or jointly execute the instructions 824 to perform all or part of any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The processor 802 may contain microcircuits that are configurable, temporarily or permanently, by some or all of the instructions 824, such that the processor 802 is configurable to perform any one or more of the methodologies described herein, in whole or in part. For example, a set of one or more microcircuits of the processor 802 may be configurable to execute one or more modules (e.g., software modules) described herein.

The machine 800 may further include a video display 810 (e.g., a plasma display panel (PDP), a light emitting diode (LED) display, a liquid crystal display (LCD), a projector, a cathode ray tube (CRT), or any other display capable of displaying graphics or video). The machine 800 may also include an alphanumeric input device 812 (e.g., a keyboard or keypad), a cursor control device 814 (e.g., a mouse, a touchpad, a trackball, a joystick, a motion sensor, an eye tracking device, or other pointing instrument), a storage unit 816, a signal generation device 818 (e.g., a sound card, an amplifier, a speaker, a headphone jack, or any suitable combination thereof), and a network interface device 820.

The storage unit 816 includes the machine-readable medium 822 (e.g., a tangible and non-transitory machine-readable storage medium) on which are stored the instructions 824 embodying any one or more of the methodologies or functions described herein, including, for example, any of the descriptions of FIGS. 1, 2, 3, 4, 5, 6, and/or 7. The instructions 824 may also reside, completely or at least partially, within the main memory 804, within the processor 802 (e.g., within the processor's cache memory), or both, before or during execution thereof by the machine 800. The instructions may also reside in the static memory 806.

Accordingly, the main memory 804 and the processor 802 may be considered machine-readable media 822 (e.g., tangible and non-transitory machine-readable media). The instructions 824 may be transmitted or received over a network 826 via the network interface device 820. For example, the network interface device 820 may communicate the instructions 824 using any one or more transfer protocols (e.g., hypertext transfer protocol (HTTP)). The machine 800 may also represent example means for performing any of the functions described herein, including the processes described in FIGS. 1, 2, 3, 4, 5, 6, and/or 7.

In some example embodiments, the machine 800 may be a portable computing device, such as a smart phone or tablet computer, and have one or more additional input components (e.g., sensors or gauges), not shown. Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 822 able to store data temporarily or permanently and may be taken to include, but not be limited to, random-access memory (RAM), read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database, or associated caches and servers) able to store instructions 824. The term “machine-readable medium” shall also be taken to include any medium, or combination of multiple media, that is capable of storing the instructions 824 for execution by the machine 800, such that the instructions 824, when executed by one or more processors of the machine 800 (e.g., processor 802), cause the machine 800 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 822 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors 802) may be configured by software (e.g., an application 140 or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 802 or other programmable processor 802. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor 802 configured by software to become a special-purpose processor, the general-purpose processor 802 may be configured as respectively different special-purpose processors (e.g., comprising different hardware modules) at different times. Software (e.g., a software module) may accordingly configure one or more processors 802, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 802 that are temporarily configured (e.g., by software) or permanently configured to perform the relevant operations. Whether temporarily or permanently configured, such processors 802 may constitute processor-implemented modules that operate to perform one or more operations or functions described herein. As used herein, “processor-implemented module” refers to a hardware module implemented using one or more processors 802.

Similarly, the methods described herein may be at least partially processor-implemented, a processor 802 being an example of hardware. For example, at least some of the operations of a method may be performed by one or more processors 802 or processor-implemented modules. As used herein, “processor-implemented module” refers to a hardware module in which the hardware includes one or more processors 802. Moreover, the one or more processors 802 may also operate to support performance of the relevant operations in a “cloud computing” environment or as a “software as a service” (SaaS). For example, at least some of the operations may be performed by a group of computers (as examples of machines 800 including processors), with these operations being accessible via a network 826 (e.g., the Internet) and via one or more appropriate interfaces (e.g., an application program interface (API)).

The performance of certain operations may be distributed among the one or more processors 802, not only residing within a single machine 800, but deployed across a number of machines 800. In some example embodiments, the one or more processors 802 or processor-implemented modules may be located in a single geographic location (e.g., within a home environment, an office environment, or a server farm). In other example embodiments, the one or more processors 802 or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine 800. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine 800 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following enumerated descriptions define various example embodiments of methods, machine-readable media 822, and systems (e.g., apparatus) discussed herein:

1. A computer implemented method comprising:

accessing a unique user identifier 410 of a user 305, the unique user identifier 410 associated with at least one form of entertainment media, the unique user identifier 410 including a user history of at least one form of the entertainment media accessed by the user 305; and
transmitting first information for displaying an offer to conduct a consumer transaction of a product associated with the at least one form of entertainment media, wherein displaying the offer is based on the user history within the accessed unique user identifier 410.

2. The method of description 1, wherein the offer includes an offer to sell a used entertainment medium product among the at least one form of entertainment media, or an offer to purchase a related entertainment medium product similar to the used entertainment medium product.

3. The method of description 1, wherein the offer includes a suggested price of an entertainment medium product, the suggested price being based on consumer aggregate data.

4. The method of description 1, wherein the at least one form of entertainment media includes video games, computer games, movies or music, and wherein the unique user identifier 410 of the user 305 includes a user account associated with a unique publisher of video games, computer games, movies or music.

5. The method of description 1, further comprising:

receiving a response to the offer to conduct the consumer transaction; and
transmitting second information for displaying a product listing of the product associated with the at least one form of entertainment media, the product listing including various information automatically filled-in used to complete the transaction.

6. The method of description 5, wherein the automatically filled-in information is based on information accessible by the unique user identifier 410.

7. The method of claim 1, wherein the unique user identifier 410 further includes a time stamp of a last occurrence of use of the at least one form entertainment media, and wherein displaying the offer is based further on determining that the last occurrence of use of the at least one form of entertainment media satisfies a time threshold.

8. An apparatus comprising an input interface, an output interface, and at least one processor 802 configured to perform any of the descriptions in descriptions 1 through 7.

9. A computer-readable medium embodying instructions 824 that, when executed by a processor 802, perform operations comprising any of the descriptions in descriptions 1 through 7.

10. An apparatus comprising means for performing any of the descriptions in descriptions 1 through 7.

What is claimed is:

1. A computer implemented method comprising:
accessing a unique user identifier of a user, the unique user identifier associated with at least one form of entertainment media, the unique user identifier including a user history of at least one form of the entertainment media accessed by the user; and
transmitting first information for displaying an offer to conduct a consumer transaction of a product associated with the at least one form of entertainment media, wherein displaying the offer is based on the user history within the accessed unique user identifier.

2. The method of claim 1, wherein the offer includes an offer to sell a used entertainment medium product among the at least one form of entertainment media, or an offer to purchase a related entertainment medium product similar to the used entertainment medium product.

3. The method of claim 1, wherein the offer includes a suggested price of an entertainment medium product, the suggested price being based on consumer aggregate data.

4. The method of claim 1, wherein the at least one form of entertainment media includes video games, computer games, movies or music, and wherein the unique user identifier of the user includes a user account associated with a unique publisher of video games, computer games, movies or music.

5. The method of claim 1, further comprising:
receiving a response to the offer to conduct the consumer transaction; and
transmitting second information for displaying a product listing of the product associated with the at least one form of entertainment media, the product listing including various information automatically filled-in used to complete the transaction.

6. The method of claim 5, wherein the automatically filled-in information is based on information accessible by the unique user identifier.

7. The method of claim 1, wherein the unique user identifier further includes a time stamp of a last occurrence of use of the at least one form entertainment media, and wherein displaying the offer is based further on determining that the last occurrence of use of the at least one form of entertainment media satisfies a time threshold.

8. A system comprising:
a memory; and
a processor coupled to the memory and configured to:
access a unique user identifier of a user, the unique user identifier associated with at least one form of entertainment media, the unique user identifier including a user history of at least one form of the entertainment media accessed by the user, and
transmit first information for displaying an offer to conduct a consumer transaction of a product associated with the at least one form of entertainment media, wherein the information for displaying the offer is based on the user history within the accessed unique user identifier.

9. The system of claim 8, wherein the offer includes an offer to sell a used entertainment medium product among the at least one form of entertainment media, or an offer to purchase a related entertainment medium product similar to the used entertainment medium product.

10. The system of claim 8, wherein the offer includes a suggested price of an entertainment medium product, the suggested price being based on consumer aggregate data.

11. The system of claim 8, wherein the at least one form of entertainment media includes video games, computer games, movies or music, and wherein the unique user identifier of the user includes a user account associated with a unique publisher of video games, computer games, movies or music.

12. The system of claim 8, wherein the processor is further configured to:
receive a response to the offer to conduct the consumer transaction; and
transmit second information for displaying a product listing of the product associated with the at least one form of entertainment media, the product listing including various information automatically filled-in used to complete the transaction.

13. The system of claim 12, wherein the automatically filled-in information is based on information accessible by the unique user identifier.

14. The system of claim 8, wherein the unique user identifier further includes a time stamp of a last occurrence of use of the at least one form entertainment media, and wherein displaying the offer is based further on determining that the last occurrence of use of the at least one form of entertainment media satisfies a time threshold.

15. A computer-readable medium embodying instructions that, when executed by a processor, perform operations comprising:
accessing a unique user identifier of a user, the unique user identifier associated with at least one form of entertainment media, the unique user identifier including a user history of at least one form of the entertainment media accessed by the user, and
transmitting first information for displaying an offer to conduct a consumer transaction of a product associated with the at least one form of entertainment media, wherein displaying the offer is based on the user history within the accessed unique user identifier.

16. The computer-readable medium of claim 15, wherein the offer includes an offer to sell a used entertainment medium product among the at least one form of entertainment media, or an offer to purchase a related entertainment medium product similar to the used entertainment medium product.

17. The computer-readable medium of claim 15, wherein the offer includes a suggested price of an entertainment medium product, the suggested price being based on consumer aggregate data.

18. The computer-readable medium of claim 15, wherein the at least one form of entertainment media includes video games, computer games, movies or music, and wherein the unique user identifier of the user includes a user account associated with a unique publisher of video games, computer games, movies or music.

19. The computer-readable medium of claim 15, further embodying instructions that, when executed by the processor perform operations further comprising:
receiving a response to the offer to conduct the consumer transaction; and
transmitting second information for displaying a product listing of the product associated with the at least one form of entertainment media, the product listing including various information automatically filled-in used to complete the transaction.

20. The computer-readable medium of claim 19, wherein the automatically filled-in information is based on information accessible by the unique user identifier.
